(19) United States
(12) Patent Application Publication
(10) Pub. No.: US 2023/0000244 A1
(43) Pub. Date: Jan. 5, 2023

(54) LIFTABLE TABLE LEG AND LIFTABLE TABLE

(71) Applicant: LUXSHARE PRECISION INDUSTRY CO., LTD., Shenzhen (CN)

(72) Inventors: Rongzheng LIN, Shenzhen (CN); Jian YI, Shenzhen (CN)

(73) Assignee: LUXSHARE PRECISION INDUSTRY CO., LTD., Shenzhen (CN)

(21) Appl. No.: 17/697,198

(22) Filed: Mar. 17, 2022

(30) Foreign Application Priority Data
Jul. 1, 2021 (CN) 202121484431.1

(51) Int. Cl. A47B 9/04; F16H 25/20

(52) U.S. Cl. CPC A47B 9/04; F16H 25/20; A47B 2200/0057; F16H 2025/209

(57) ABSTRACT

A liftable table leg includes a bushing, a second fixing piece, a lift assembly, a fixing base and a drive assembly. A first fixing piece is sleeved on a first end of the bushing. The second fixing piece includes a fixing flange and an accommodation groove. The first end is fixed to a bottom end of the accommodation groove through the first fixing piece. A nut of the lift assembly is fixedly disposed at a second end of the bushing. A lead screw of the lift assembly is rotatably disposed in the bushing and threaded into the nut. The second fixing piece is fixedly disposed at the fixing base through the fixing flange. The drive assembly includes a fixing frame. An end of the lead screw is rotatably connected to the fixing frame, and the drive assembly is capable of driving the lead screw to rotate.

### CROSS-REFERENCE TO RELATED APPLICATION(S)

This application claims priority to Chinese Patent Application No. 202121484431.1 filed Jul. 1, 2021, the disclosure of which is incorporated herein by reference in its entirety.

### TECHNICAL FIELD

The present disclosure relates to the technical field of liftable tables and, in particular, to a liftable table leg and a liftable table.

### BACKGROUND

Unfit student tables can affect children's physical health. In China, school-age children can't do their homework, or use computers, or read without student tables every day. Improper height and posture may cause children's myopia, hunchback and even scoliosis. Therefore, when selecting a student table or chair, the height of the user is taken into account so as to select a table or chair of an appropriate height.

At present, most of the lifting and lowering methods of the two-section liftable tables in the market are mainly carried out by the screw movement inside the legs of the table on both sides. The movement range of the large-sector product is 720 mm to 1200 mm, resulting in the inconvenience of the use of minors or shorter people.

In response to the above-mentioned problems, it is necessary to develop a liftable table leg and a liftable table to solve the problem of inconvenient use of minors or shorter people due to a high minimum height of the liftable table.

### SUMMARY

The present disclosure provides a liftable table leg and a liftable table, which can reduce the lowest height of the liftable table to be suitable for minors or shorter people.

The present disclosure adopts solutions described below.

A liftable table leg includes a bushing, a second fixing piece, a lift assembly, a fixing base, and a drive assembly.

A first fixing piece is sleeved on a periphery of a first end of the bushing.

The second fixing piece includes a fixing flange and an accommodation groove. The first end is fixed to a bottom end of the accommodation groove through the first fixing piece.

The lift assembly includes a lead screw and a nut. The nut is disposed coaxially with the bushing and fixedly disposed at a second end of the bushing. The lead screw is rotatably disposed in the bushing and threaded into the nut.

The fixing base is provided with a through hole. The second fixing piece is inserted into the through hole and fixedly disposed at the fixing base through the fixing flange.

The drive assembly includes a fixing frame. An end of the lead screw passing through the nut is rotatably connected to the fixing frame, and the drive assembly is configured to drive the lead screw to rotate.

A liftable table includes a table plate and the at least two liftable table legs. The table plate is fixedly connected to a fixing frame of each of the at least two liftable table legs.

### BRIEF DESCRIPTION OF DRAWINGS

FIG. 1 is a left view of a liftable table leg according to the present disclosure:

FIG. 2 is a sectional view of part A-A of FIG. 1 according to the present disclosure;

FIG. 3 is a partial enlarged view of part B of FIG. 2 according to the present disclosure;

FIG. 4 is a partial enlarged view of part C of FIG. 2 according to the present disclosure;

FIG. 5 is a structural view of a drive assembly according to the present disclosure; and

FIG. 6 is a structural view of a liftable table according to the present disclosure.

### REFERENCE LIST

1. Bushing
2. Second fixing piece
3. Lift assembly
4. Fixing base
5. Support base
6. Drive assembly
7. Guide assembly
8. Table plate
9. Control assembly
11. First end
12. Second end
13. First fixing piece
21. Fixing flange
22. Accommodation groove
31. Lead screw
32. Nut
61. Drive motor
62. Worm
63. Worm gear
71. First sleeve
72. Second sleeve
73. Gap filler
81. Fixing rib
311. Sliding block
321. Cushion

### DETAILED DESCRIPTION

Embodiments of the present disclosure are described in detail below. Examples of the embodiments are illustrated in the drawings. The same or similar reference numerals indicate the same or similar elements or elements having the same or similar functions. The embodiments described below with reference to the drawings are exemplary, intended to explain the present disclosure.

In the description of the present disclosure, it should be noted that the orientations or position relations indicated by terms such as center”, “above”, “below”, “left”, “right”, “vertical”, “horizontal”, “inside”, “outside”, and the like are based on orientations or position relations shown in the drawings. These orientations or position relations are intended only to facilitate and simplify description of the present disclosure and not to indicate or imply that a device or element referred to must have such specific orientations or must be configured or operated in such specific orientations. In addition, terms such as “first” and “second” are used merely for the purpose of description and are not to be construed as indicating or implying relative importance. For example, the terms “first position” and “second position” are two different positions.

Unless otherwise expressly specified and limited, the term “mounting”, “connected to each other”, “connected” or “fixed” is to be construed in a broad sense, for example, as fixedly connected, detachably connected, mechanically connected or electrically connected; directly connected to each other or indirectly connected to each other via an intermediary; or internally connected or interactional relationships between two components. For those of ordinary skill in the art, specific meanings of the above terms in the present disclosure can be understood according to specific conditions.

Unless otherwise expressly specified and limited, when a first feature is described as “above” or “below” a second feature, the first feature and the second feature may be in direct contact or be in contact via another feature between the two features. Moreover, when the first feature is described as “on”, “above”, or “over” the second feature, the first feature is right on, above, or over the second feature or the first feature is obliquely on, above, or over the second feature, or the first feature is simply at a higher level than the second feature. When the first feature is described as “under”, “below” or “underneath” the second feature, the first feature is right under, below, or underneath the second feature or the first feature is obliquely under, below, or underneath the second feature, or the first feature is simply at a lower level than the second feature.

Solutions of the present disclosure are further described below through embodiments in conjunction with the drawings.

A liftable table leg is provided in the present embodiment. As shown in FIGS. 1 to 4, the liftable table leg includes a bushing 1, a second fixing piece 2, a lift assembly 3, a fixing base 4, and a drive assembly 6. A first fixing piece 13 is sleeved on a periphery of a first end 11 of the bushing 1. The second fixing piece 2 includes a fixing flange 21 and an accommodation groove 22. The first end 11 is fixed to a bottom end of the accommodation groove 22 through the first fixing piece 13. The lift assembly 3 includes a lead screw 31 and a nut 32. The nut 32 is disposed coaxially with the bushing 1 and fixedly disposed at a second end 12 of the bushing 1. The lead screw 31 is rotatably disposed in the bushing 1 and threaded into the nut 32. The fixing base 4 is provided with a through hole. The second fixing piece 2 is inserted into the through hole and fixedly disposed at the fixing base 4 through the fixing flange 21. The drive assembly 6 includes a fixing frame. An end of the lead screw 31 passing through the nut 32 is rotatably connected to the fixing frame, and the drive assembly 6 is capable of driving the lead screw 31 to rotate.

For the liftable table leg, a fixed block traditionally disposed at the bottom of the lead screw 31 is removed. The first fixing piece 13 is sleeved outside the bushing 1 so that the lead screw 31 is capable of penetrating the first fixing piece 13. Therefore, the thickness of the first fixing piece 13 does not affect the net stroke of the lead screw 31. Meanwhile, the bushing 1 is fixed in the accommodation groove 22 of the second fixing piece 2 through the first fixing piece 13, and the second fixing piece 2 is inserted into the through hole of the fixing base 4. Therefore, the lead screw 31 is capable of being closer to the ground and the net lift stroke of the lead screw 31 is capable of being further increased. The drive assembly 6 drives the lead screw 31 to rotate. As the nut 32 is fixedly connected to the bushing 1, the lead screw 31 moves up and down with respect to the nut 32 during rotation. The drive assembly 6 moves up and down synchronously with the lead screw 31 through the fixing frame to ensure that the drive assembly 6 is capable always of driving the lead screw 31 to rotate.

Optionally, the liftable table leg further includes a sliding block 311. As shown in FIG. 4, the sliding block 311 is disposed at an end of the lead screw 31 away from the nut 32, and the periphery of the sliding block 311 abuts against the inner wall of the bushing 1. Due to the long legs of the table, when the end of the lead screw 31 away from the nut 32 rotates closer to the bottom of the lead screw 31, the lead screw 31 is capable of not always remaining coaxial with the bushing 1. Therefore, the lead screw 31 will shake, causing the table legs to be unable to be stable. The sliding block 311 is capable of filling the gap between the end of the lead screw 31 away from the nut 32, and the bushing 1, so that the lead screw 31 is always coaxial with the bushing 1, and the liftable table leg is always stable during the lifting process.

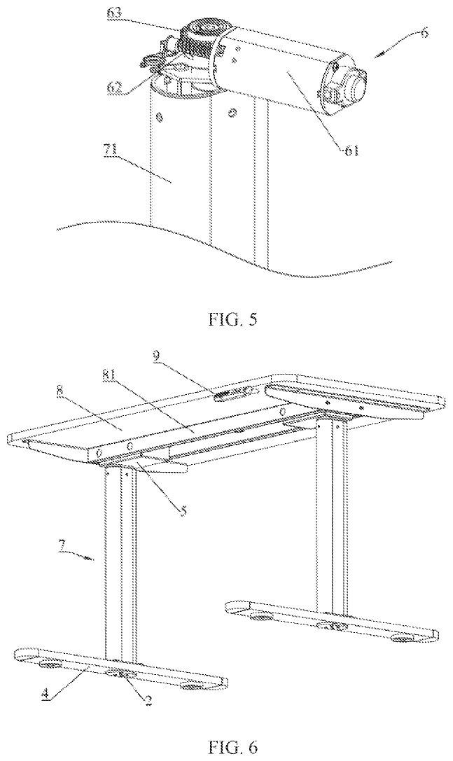

As shown in FIG. 5, the liftable table leg further includes a support base 5. The drive assembly 6 is fixedly disposed in the support base 5 through the fixing frame. The support base 5 is capable of covering the drive assembly 6, making the liftable table leg more aesthetic and protecting the drive assembly 6.

The drive assembly 6 includes a drive motor 61, a worm 62, and a worm gear 63. The drive motor 61 is fixedly disposed at the fixing frame. The worm 62 is in transmission connection with an output end of the drive motor 61. The worm gear 63 is rotatably disposed at the fixing frame and is capable of rotating under the driving of the worm 62. The end of the lead screw 31 closer to the fixing frame passes through the worm gear 63, and rotates synchronously with the worm gear 63. The drive motor 61 is capable of providing power for adjusting the liftable table leg. The worm gear 63 and the worm 62 are capable of changing the transmission direction so that the drive motor 61 is capable of being disposed laterally without occupying the space at the top of the liftable table leg. Meanwhile, the worm gear 63 and the worm 62 are capable of achieving a certain deceleration effect, so that the adjustment speed of the liftable table leg is very smooth.

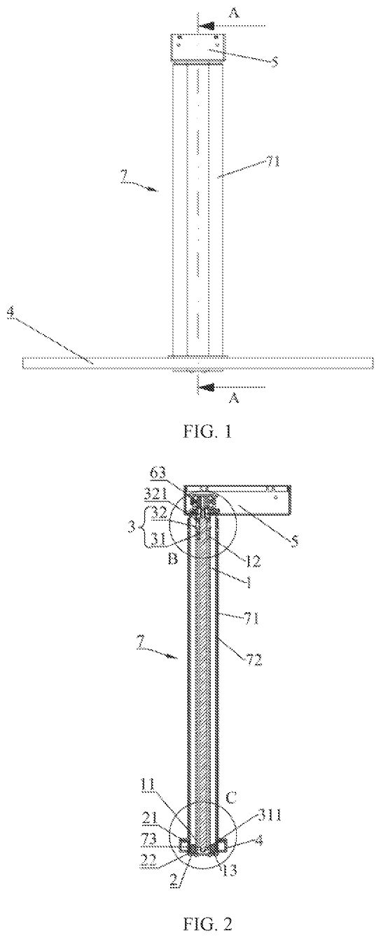

Optionally, the liftable table leg further includes a guide assembly 7. The guide assembly 7 includes a first sleeve 71 and a second sleeve 72. An end of the first sleeve 71 is fixedly disposed at the second fixing piece 2 (as shown in FIGS. 2 to 4). An end of the second sleeve 72 is fixedly disposed at the fixing frame, and one of the first sleeve 71 or the second sleeve 72 is sleeved outside the other. The first sleeve 71 and the second sleeve 72 is capable of further improving the stability of the liftable table leg during the lifting process. Meanwhile, the first sleeve 71 and the second sleeve 72 are also capable of hiding the related parts controlling the lifting inside. Therefore, the appearance of the liftable table leg is more aesthetic.

Optionally, the liftable table leg further includes a gap filler 73. A gap is provided between the first sleeve 71 and the second sleeve 72. The gap filler 73 is fixedly disposed at the first sleeve 71 or the second sleeve 72, and the gap filler 73 circumferentially fills the gap between the first sleeve 71 and the second sleeve 72. The first sleeve 71 and the second sleeve 72 each have certain hardness. When the first sleeve 71 and the second sleeve 72 are in contact with each other, relative sliding will generate relatively large noise and relatively great friction, which seriously degrades the user experience. The gap filler 73 is capable of making the first sleeve 71 and the second sleeve 72 space apart by a certain gap, greatly reducing noise during sliding. Meanwhile, the gap filler 73 may be made of the material having a smooth surface. Therefore, the friction between the first sleeve 71 or the second sleeve 72 and the gap filler 73 can be reduced. The user can adjust the height of the liftable table leg more conveniently.

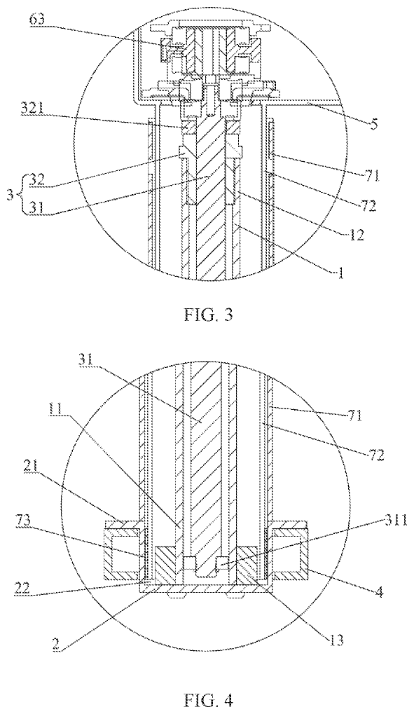

When the liftable table leg is lowered to the lowest height, the fixing frame will collide with the nut 32, easily causing damage to the liftable table leg and generating relatively large noise. In order to solve this problem, as shown in FIG. 3, the liftable table leg further includes a cushion 321. The cushion 321 is fixedly disposed at the side of the nut 32 closer to the fixing frame. Moreover, the cushion 321 is provided with a through hole, and the lead screw 31 passes through the through hole.

The position between the cushion 321 and the nut 32 is relatively fixed. The cushion 321 is bonded and fixed to the nut 32 so as to reduce the assembly cost in the production process. In this manner, during assembly, an operator can assemble and fix the bonded cushion 321 and the nut 32 at one time, thereby improving assembling efficiency.

This embodiment also provides a liftable table. The liftable table uses at least two liftable table legs. When the bottom end of the lead screw 31 is closer to the bottom surface of the accommodation groove 22, the liftable table is at the lowest height. Not affected by the thickness of the second fixing piece 2 and the thickness of the fixing base 4, the liftable table is convenient for use by minors or shorter people.

As shown in FIG. 6, the liftable table includes a table plate 8 and the at least two liftable table legs. The table plate 8 is fixedly connected to the fixing frame of two liftable table legs. It is to be understood that the two liftable table legs are respectively located at two ends of the table plate 8 to maintain stability.

Optionally, two fixing ribs 81 are disposed on a lower side of the table plate 8. The fixing frame is clamped between the two fixing ribs 81 and fixed to the two fixing ribs 81 through screws. The fixing frame abuts against the bottom of the table plate 8 to support the table plate 8. The two fixing ribs 81 are capable of fixing the fixing frame. Moreover, because the fixing ribs 81 are located between the two liftable table legs, the fixing ribs 81 are also capable of supporting the table plate 8 to enhance the strength of the table plate 8 and prevent the table plate 8 from falling.

It is to be understood that when the liftable table leg is provided with the support base 5, the table plate 8 is directly and fixedly connected to the support base 5 through two fixing ribs 81. The distance between the two fixing ribs 81 is equal to the width of the support base 5.

Optionally, the liftable table further includes a control assembly 9. The control assembly 9 is disposed under the table plate 8, and the control assembly 9 is electrically connected to the drive assembly 6. The control assembly 9 is capable of controlling the drive assembly 6 to drive the lifting of the liftable table leg. The user can control the movement of the drive assembly 6 in realtime through the control assembly 9 so as to adjust the table plate 8 to an appropriate height.

The present disclosure provides a liftable table leg and a liftable table. For the liftable table leg, a fixed block at the bottom of the lead screw is removed. The first fixing piece is sleeved outside the bushing so that the lead screw is capable of penetrating the first fixing piece. Therefore, the thickness of the first fixing piece does not affect the net stroke of the lead screw. Meanwhile, the bushing is fixed in the accommodation groove of the second fixing piece through the first fixing piece, and the second fixing piece is inserted into the through hole of the fixing base. Therefore, the lead screw is capable of being closer to the ground and the net lift stroke of the lead screw is capable of being further increased.

The liftable table uses at least two liftable table legs. When the liftable table is used and the bottom end of the lead screw is closer to the bottom surface of the accommodation groove, the liftable table is at the lowest height. Not affected by the thickness of the second fixing piece and the thickness of the fixing base, the liftable table is convenient for use by minors or shorter people.

What is claimed is:

1. A liftable table leg, comprising:
a bushing, wherein a first fixing piece is sleeved on a periphery of a first end of the bushing;
a second fixing piece, wherein the second fixing piece comprises a fixing flange and an accommodation groove, and the first end is fixed to a bottom end of the accommodation groove through the fixing piece;
a lift assembly, wherein the lift assembly comprises a lead screw and a nut, the nut is disposed coaxially with the bushing and fixedly disposed at a second end of the bushing, and the lead screw is rotatably disposed in the bushing and threaded into the nut;
a fixing base, wherein the fixing base is provided with a through hole, the second fixing piece is inserted into the through hole and fixedly disposed at the fixing base through the fixing flange; and
a drive assembly, wherein the drive assembly comprises a fixing frame, an end of the lead screw passing through the nut is rotatably connected to the fixing frame, and the drive assembly is configured to drive the lead screw to rotate.

2. The liftable table leg according to claim 1, further comprising a sliding block, wherein the sliding block is disposed at an end of the lead screw away from the nut, and a periphery of the sliding block abuts against an inner wall of the bushing.

3. The liftable table leg according to claim 1, further comprising a support base, wherein the drive assembly is fixedly disposed in the support base through the fixing frame.

4. The liftable table leg according to claim 1, wherein the drive assembly further comprises:
a drive motor, wherein the drive motor is fixedly disposed at the fixing frame;
a worm, wherein the worm is in transmission connection with an output end of the drive motor; and
a worm gear, wherein the worm gear is rotatably disposed at the fixing frame and is configured to rotate under driving of the worm, and an end of the lead screw closer to the fixing frame passes through the worm gear, and is configured to rotate synchronously with the worm gear.

5. The liftable table leg according to claim 4, further comprising a guide assembly, wherein the guide assembly comprises:
a first sleeve, wherein an end of the first sleeve is fixedly disposed at the second fixing piece; and
a second sleeve, wherein an end of the second sleeve is fixedly disposed at the fixing frame, and one of the first sleeve or the second sleeve is sleeved outside another of the first sleeve or the second sleeve.

6. The liftable table leg according to claim 5, further comprising a gap filler, wherein a gap is provided between the first sleeve and the second sleeve, the gap filler is fixedly disposed at the first sleeve or the second sleeve, and the gap filler circumferentially fills the gap between the first sleeve and the second sleeve.

7. The liftable table leg according to claim 1, further comprising a cushion, wherein the cushion is fixedly disposed at a side of the nut facing towards the fixing frame, and the cushion is provided with a through hole, the lead screw passes through the through hole.

8. The liftable table leg according to claim 7, wherein the cushion is bonded and fixed to the nut.

9. A liftable table, comprising a table plate and at least two liftable table legs according to claim 1, wherein the table plate is fixedly connected to a fixing frame of each of the at least two liftable table legs.

10. The liftable table according to claim 9, wherein two fixing ribs are provided on a lower side of the table plate, and the fixing frame is clamped between the two fixing ribs and fixed to each of the two fixing ribs through screws.

11. The liftable table according to claim 9, wherein the liftable table leg further comprises a sliding block, wherein the sliding block is disposed at an end of the lead screw away from the nut, and a periphery of the sliding block abuts against an inner wall of the bushing.

12. The liftable table according to claim 9, wherein the liftable table leg further comprises a support base, wherein the drive assembly is fixedly disposed in the support base through the fixing frame.

13. The liftable table according to claim 9, wherein the drive assembly further comprises:
a drive motor, wherein the drive motor is fixedly disposed at the fixing frame;
a worm, wherein the worm is in transmission connection with an output end of the drive motor; and
a worm gear, wherein the worm gear is rotatably disposed at the fixing frame and is configured to rotate under driving of the worm, and an end of the lead screw closer to the fixing frame passes through the worm gear, and is configured to rotate synchronously with the worm gear.

14. The liftable table according to claim 13, wherein the liftable table leg further comprises a guide assembly, wherein the guide assembly comprises:
a first sleeve, wherein an end of the first sleeve is fixedly disposed at the second fixing piece; and
a second sleeve, wherein an end of the second sleeve is fixedly disposed at the fixing frame, and one of the first sleeve or the second sleeve is sleeved outside another of the first sleeve or the second sleeve.

15. The liftable table according to claim 14, wherein the liftable table leg further comprises a gap filler, wherein a gap is provided between the first sleeve and the second sleeve, the gap filler is fixedly disposed at the first sleeve or the second sleeve, and the gap filler circumferentially fills the gap between the first sleeve and the second sleeve.

16. The liftable table according to claim 9, wherein the liftable table leg further comprises a cushion, wherein the cushion is fixedly disposed at a side of the nut facing towards the fixing frame, and the cushion is provided with a through hole, the lead screw passes through the through hole.

17. The liftable table according to claim 16, wherein the cushion is bonded and fixed to the nut.
